(19) United States
(12) Patent Application Publication
(10) Pub. No.: US 2014/0046896 A1
(43) Pub. Date: Feb. 13, 2014

(54) Automated Extraction and Reporting on Applicant Private Social Network Information

(71) Applicant: Kevin Grant Potter, Rancho Santa Fe, CA (US)

(72) Inventor: Kevin Grant Potter, Rancho Santa Fe, CA (US)

(21) Appl. No.: 13/762,172

(22) Filed: Feb. 7, 2013

Related U.S. Application Data
(60) Provisional application No. 61/682,552, filed on Aug. 13, 2012.
(60) Provisional application No. 61/698,597, filed on Sep. 8, 2012.

(51) Int. Cl. G06F 17/30

(52) U.S. Cl. CPC G06F 17/30554
USPC 707/603

(57) ABSTRACT

A system and computer implemented method, in the case of pre-employment screening and where other commercial goods and services require review of an individual (ie an Applicant), wherein a Reviewer uses an automated, efficient permission based system to identify and access private and semi-private information of an Applicant maintained in their social network accounts, with particular benefit where these have privacy settings. The system initiates a Reviewer request, automates the Applicant's identification of and approval to their social network and automates the retrieval of relevant information and reporting to the Reviewer. The process can be initiated by either the Reviewer or the Applicant. The system filters for potential legally discriminatory protected class information from the Reviewer residing in social network accounts and returns relevant information in an efficient, automated and permission based manner.

This application claims the benefit of U.S. Provisional Application Ser. No. 61/682,552, filed Aug. 13, 2012, and U.S. Provisional Application Ser. No. 61/698,597, filed Sep. 10, 2012, the substance of which is incorporated herein in their entirety.

### FIELD OF THE INVENTION

The present invention relates to a unique process and method whereby prospective employers or providers of goods and services can gather or be presented with private information on an Applicant residing in online social networks using an automated, permission based service as part of their assessment of the Applicant.

### BACKGROUND OF THE INVENTION

Prospective employees are often subject to background and pre-employment checks, or screening. These checks often include detailed background searches, including for criminal records, drug testing and social security number verification. These checks may include character references and to this end, references from third parties (eg references from prior employers) and publicly available information on the world wide web is often scrutinized. Screening often occurs not only in pre-employment but where a party applies (ie an “Applicant”) to a third party for a product or service, for example admission to college or the purchase of a life insurance policy.

Social networks are tools that help capture an Applicant's social activities, by linking together, in a centralized manner, friends, family, colleagues, acquaintances and events associated with an applicant. The events, for example, span from photographs; personal comments made and posted by the applicant to his network; personal and private messages sent within the social network direct to a person associated in the social network with the Applicant. Social networks provide people a partial repository of their digital life which has become increasingly popular and important.

A user of a social network can enable privacy settings. With the incidence of identity theft, online fraud and default privacy settings applied by social networks, most users of social networks have privacy settings that do not allow a public view of their private information and activity within the social network. This information is then not available to third parties who wish to perform in-depth screening of the Applicant. In addition, laws and issues of privacy continue to evolve.

With a competitive job market, some Applicants may wish to voluntarily provide private social network information to third parties (“Reviewers”) who are not ordinarily on their social network, as a means to improve their attractiveness as Applicants by providing more information for Reviewers.

The invention anticipates a future emergent need for (i) third parties to holistically assess an Applicant yet this is thwarted by privacy settings, which by their very design in social networks prevent access to private information, and for Reviewers to initiate a request for Applicant information, or (ii) Applicants initiating and provisioning their own self-reporting of private social network information in a manner proposed to prospective Reviewers. In addition, the system and method filters, or attempts to filter, potentially legally discriminatory protected class information that exposes a Reviewer to potential legal risk simply by being exposed or seeing certain information (for example, age, gender, health status indicators, sexual lifestyle indicators). The invention addresses both these needs through a novel, non-obvious and automated system and method.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one embodiment, the invention comprises a computer implemented method configured to provide a third party who wishes to review (“Reviewer”) the private social network information of a person seeking employment or applying for a position or service (“Applicant”), the ability to use software or a web-based service to initiate automated and permission based approval from the Applicant, to access their private and semi-private information across various social networks.

In one embodiment, the invention comprises a computer implemented method configured to provide an Applicant a means to initiate, extract and report on their private social network information across various social networks, regardless of privacy settings, and provision this information to a public third party Reviewer who is ordinarily external to the Applicants social network for the purposes of a person seeking employment or applying for a position or service, and the ability to use software or a web-based service to initiate automated processes by Applicant, to access and report on their private and semi-private information across various social networks.

In one embodiment, the invention comprises a computer implemented method configured to provide an Applicant a means to initiate, extract and report on their private social network information across various social networks, regardless of privacy settings, and provision this information to a public third party Reviewer who is ordinarily external to the Applicants social network for the purposes of a person seeking employment or applying for a position or service, and the ability to use software or a web-based service to initiate automated processes by Applicant, to access and report on their private and semi-private information across various social networks.

In some embodiments, the invention comprises an automated computer implemented method configured to allow the Applicant to grant or deny such approval requested by the Reviewer to identify the Applicant's social network designated accounts pertaining to the Applicant and grant or deny access to the private and semi-private information of the Applicant to the Reviewer within the Applicants accounts on the identified social networks. In some embodiments, this process comprises a set of automated messages (such as emails or webpages) and websites wherein social network profiles, credentialing and verifications are provided by the Applicant.

In some further embodiments, the present invention comprises an automated system to gather, based on permission-based access granted by the Applicant, private and semi-private information from the Applicants social network accounts. This is executed even if the social network accounts have Privacy settings residing in the social networks turned On. The automated system gathering of information includes both direct access into a social network using the social network approved API (Application Programming Interface), internet iFrames (Inline Frames) and other internet protocols to collect the information from the Applicant's social network accounts both on a stored information or real-time basis.

In some embodiments, the methods of the present invention are configured to filter or otherwise exclude (or attempt to exclude), potential discriminatory or harmful information sets in both gathering and displaying of information associated with an Applicant. These discriminatory information sets are typically data points of the Applicant that reside in their social network accounts and are generally defined by law as ‘protected class’ category information and includes but is not limited to race, gender, religion, disability, sexual orientation, marital status, political affiliation, age and others. In some embodiments, the computer implemented method for filtering includes the automated process in firstly not gathering certain information categories from the social network accounts of the Applicant, and secondly using key word and other algorithms to exclude or identify potential discriminatory harmful information sets.

In yet some further embodiments, a graphical user interface is provided. The graphical user interface comprises a multi-facetted window in an electronic communication application, wherein the private and semi-private information from the Applicant's approved social network accounts are displayed to the Reviewer. In some embodiments, the graphical user information may have access permissions applied and also includes a method and display for the Reviewer or person with approved access to the graphical user interface, to apply a rating system and include comments to the appropriateness of the private and semi-private gathered information returned or displayed by the Applicant's social network accounts.

In some additional embodiments, the computer implemented methods of the present invention are configured to allow a Reviewer to distribute the information obtained from the private social media profiles of an Applicant to other third parties of the private and personal information of the Applicant they receive firstly by granting user based access to the graphical user interface, or by distributing the content displayed by the graphical user interface in the form of a report capable of being interpreted or accessed by an internet browser (including PDF, Portable Document Format, webpage, etc,), or by distributing the data in a manner capable of being received by another computer into another third party computer system through the provision of an API (Application Programming Interface) from the system that serves information to the graphical user interface, for the purposes of providing the information to a third party computer system.

In some embodiments, the computer implemented methods of the present invention are configured to allow an Applicant to receive extracted reports of the information obtained from their social media profiles in the form of a report capable of being interpreted by an internet browser (including PDF, Portable Document Format, webpage etc) and the Applicant then determining to distributing the data in such report form to any Reviewer the Applicant so chooses to share the report with. The Applicant can request that the private social network information shared in the report remain either private to the Reviewer or to become public (ie the Reviewer can share the information with other third parties).

The techniques disclosed herein may promote pre-employment screening and the application process for other positions, services or products to a third party where (i) such third party requires or requests permission based social network information access using an efficient automated system to better understand an Applicant in their assessment process, or (ii) the Applicant wishes to improve the probability of their selection by the Reviewer by initiating and voluntarily providing such information to the Reviewer without the requirement imposed by the Reviewer.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

Briefly, the present invention comprises a computer implemented method for a third party Reviewer to receive or request a report of private and semi-private social network information from multiple social network accounts from an Applicant; and the process can be initiated by the Reviewer or the Applicant; and in the first instance the Applicants approval of such request; and using an automated system to extract the private and semi-private information from one or many of the Applicants private social network accounts using an automated system; and presenting the extracted information to the Reviewer through a graphical user interface or direct to a third party system; and a method for the Reviewer to include input into the extracted information and share the reports with other third parties; and a method for the Applicant to receive a report of the information and determining to share the report with a Reviewer; with the effect that private social network information can potentially become part of the public domain using an automated permission based system.

Furthermore, the method described above wherein the initiation of an electronic request to an Applicant by a Reviewer uses a manual method of selecting the initiation action.

Furthermore, the method described above wherein the initiation of an electronic request to an Applicant by a Reviewer uses a manual or an automated method of selecting the initiation action through system software code embedded in the Reviewer business process (ie the process commences without the need for manual intervention by a Reviewer but is started by the software code of a business process application used by the Reviewer).

Furthermore, the method described above wherein the automated service request by electronic message (email, instant messenger, webpages, text message or similar) to the Applicant to identify their social network accounts and approve or deny the service access to the private social network accounts through providing access credentials to the system to the various social network accounts.

Furthermore, the method described above where in one embodiment, the Applicant, independent of the Reviewer, initiates the system of collecting their private social network information through selecting an initiation action accessing the system software by pressing a digital button on an electronic internet browser compatible computer interface to the system (that is, the process commences without the need for process intervention by a Reviewer).

Furthermore, the method described above wherein the system uses a compilation component to extract and compile semi-private and private information from the Applicants social network accounts through internet protocols or API (Application Programming Interface) with Applicant stored credentials into the social networks.

Furthermore, the method described above wherein, using a system compilation component to extract information that does not gather, or attempts to exclude, information from the Applicants information that would be potentially harmful for the Reviewer to receive (a Protected Class Filter), for example, protected class information that could be deemed discriminatory such as gender, age or date of birth, health or sexual orientation status indicators recorded in the social network accounts.

Furthermore, the method described above wherein, the electronic communication application to report comprising at least one of the following: a graphical user interface of the Applicants information retrieved from the social with the functions for a Reviewer to add input commentary and ratings of the reviewed retrieved information and produce and share reports (including PDF, Portable Document Format) the Reviewer can use to send to other third parties; and an API (Application Programming Interface) for the system to provide the Applicants retrieved private social network information to a third party computer system; and a system able to produce and extract reports (including PDF, Portable Document Format) to the Applicant who can subsequently determine to share such reports with one or multiple Reviewers.

### BRIEF DESCRIPTION OF THE DRAWINGS

FIG. 1 shows one example of a method whereby a request for permission based access is initiated by a Reviewer.

FIG. 2 illustrates one example of a process that the system uses for an Applicant to initiate the process, or to grant or deny automated access to their various social network accounts where the Reviewer initiates the process.

FIG. 3 presents one example of a process whereby the system automatically gathers information from the Applicant's social networks.

FIG. 4 presents one example of a manner in which the system returns information to the Applicant or to the Reviewer of the Applicant's information returned from the social networks.

### DETAILED DESCRIPTION OF THE INVENTION

As used herein, the term “computer” or “server” refers to a machine, apparatus, mobile phone or device that is capable of accepting and performing logic operations from software code. The term “software”, “software code” or “computer software” refers to any set of instructions operable to cause a computer to perform an operation. Thus, the methods and systems of the present invention may be performed by a computer based on instructions received by computer software.

The claimed subject matter is now described with reference to the drawings and for the purposes of explanation, specific details are set forth in order to provide a thorough understanding of the claimed subject matter. It may be evident, however, that the claimed subject matter may be practiced without these specific details. In other instances, methods and systems are illustrated in block diagram form in order to facilitate describing both a detailed and broad understanding of the claimed subject matter.

The purpose of the claimed subject matter is to use a novel, automated and permission based system for a Reviewer to gain access to otherwise determined private information stored within a person's (who is seeking employment or other goods or services, being the Applicant) private social networks in order that a more thorough assessment of the Applicant can be performed by the Reviewer. This is achieved through a process initiated by the Reviewer or the Applicant.

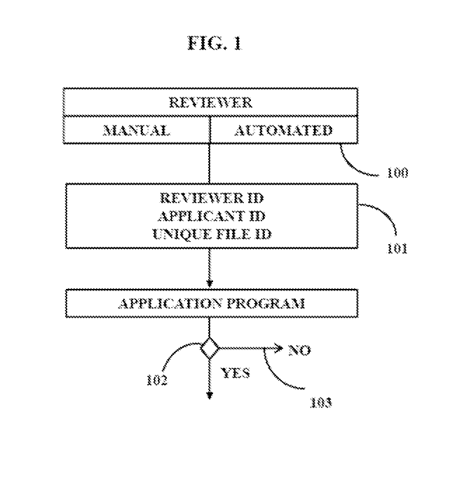

FIG. 1 illustrates one example of a computer implemented method of the present invention. When referring to FIG. 1, the method of initiating a request for permission by a Reviewer to an Applicant is shown. Typically a Reviewer will review multiple Applicants. On selecting one or multiple Applicants, the Reviewer would then wish to private or semi-private (eg contained in a social network accessible only to those with permission to view, for example “friends” is a widely used access right within social networks) information to better assess the Applicant.

The Reviewer: Applicant relationship for which the subject matter is claimed is in both a specific and broad sense. In a specific sense, this for example would represent a pre-employment situation where the Applicant is a prospective employee and the Reviewer is a prospective employer or a service provider to acquire or screen prospective employees for prospective employers (for example employers, recruiters, job boards and back ground checkers). In a broad sense the Reviewer: Applicant relationship pertains to where a third party wishes to gain additional private social network information on an individual's private and personal social network to assess the suitability of the Applicant; for example for a college or their service providers (Reviewer) and prospective student (Applicant); for example a life insurer financial provider or their service providers (Reviewer) and prospective individual who seeks insurance cover (Applicant). The broad sense is defined by a relationship that is defined as by and between two independent third parties who wish to enter into relationship that at the base is not purely social or personal in nature and is defined by an underlying actual or intended financial or commercial relationship.

By way of a non-limiting example, in FIG. 1, the Reviewer determines (either manually or using electronic assessment software) they wish to review information of the Applicant (or multiple Applicants) maintained in their online digital social networks. This initial determination can be through human review or pre-determined electronic assessment systems. Social networks are where internet accessible electronic networks share public, private and semi-private information and connect people and for illustration include but are not limited to Facebook, Twitter, LinkedIn and constantly evolving social networks. In 100, the Reviewer instructs the system to initiate an approval request to the Applicant. This can be performed manually, for example the Reviewer manually pressing a digital button on an electronic interface provided by the system; or can be initiated procedurally and in an automated manner by system software code embedded in, and forming part of, the Reviewers business process.

In FIG. 1, upon initiating in 100, the method requests from the Reviewer (either through a digital manual input or digital collection from the business process) a data packet containing authentication information of the Reviewer (which may be manual or electronic authorization token identification based from the Reviewer or the Reviewer's computer system) and of the approval to be requested. This is illustrated in 101 and the system will transmit identification of the approval to be requested and will contain at least identification of the Reviewer (the Reviewer ID), the Applicant (Applicant ID) and a Unique File ID that the Reviewer uses to track the Applicant. The Reviewer ID and Applicant ID can take any digital form sufficient to uniquely identify the said person or entity and may take the form of email address, instant messenger or other electronic identifier.

In FIG. 1, the Application Program on receiving the data packet request from the Reviewer will in 102 authenticate the Reviewer as a user of the system and who is authorized to initiate an approval request from the Applicant. A Reviewer may not be authorized on various premises including membership, payments of fees and others, and if not authorized the system per 103 rejects and terminates the approval request and informs the Reviewer.

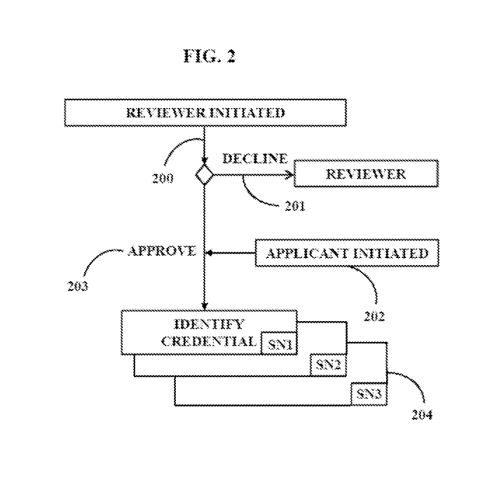

In FIG. 2, the example of an approved approval request per 200 is then automatically generated by the system in electronic form to the Applicant, for example email, instant messenger, webpage or other electronic form. On receipt, the Applicant can elect to Approve in 202, or Decline in 201, the system request to identify and gather private or semi-private information from the Applicants social network accounts. The Applicant elects to Approve or Decline based on an electronic selection they make in the electronic approval request sent to the Applicant. On selecting to Decline in 201, the system returns an electronic message (either email, instant messenger, webpage or the system messaging directly into the Reviewers system or other electronic means) to the Reviewer and the process is terminated.

In one embodiment, the process is not initiated by the Reviewer but is initiated by the Applicant as shown in 202. For example, the Reviewer is made aware of the service by other means (for example advertising) and they access the service independently of the Reviewer process contained in 100 to 201.

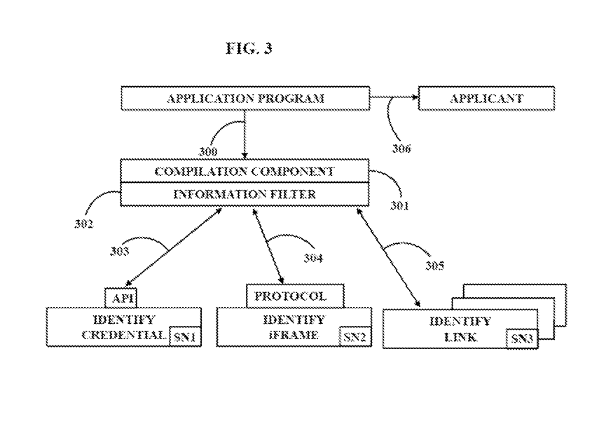

With the Approval of the Applicant of the system in FIG. 2 that they approve the Reviewer having access to their private and semi-private information on their social networks by their selection in 200, or where the Applicant initiates the process independently of the Reviewer in 202, then the system initiates 203 which approval shall require acceptance of the terms and conditions of the system by the Applicant and (i) in an electronic interface provided by the system request that the Applicant identify and validate to the system their personal accounts maintained on those social networks specified by the system (ii) where applicable, provide to the system such authorization credentials, authorizations and authorization tokens (in total, the Credentials) to the social network for the system to make electronic access directly into the social network using such stored Credentials at a later stage through the approved social network API (Application Programming Interface), refer FIG. 3 303. The system will test the acceptability of the provided credentials automatically in process 203 through the social network provided interface API. There may be zero, one or more likely multiple social networks that are likely to be identified, Credentialed and accessed for a single Applicant in 204.

The system and process benefit of this component includes permission based access to private social network accounts, limitation of liability terms for the Reviewer and the system provider in the process of 203, providing later automated access to the private social network accounts (FIG. 3) and then validation of specific social network accounts by the Applicant given the risk associated with the commonality of names and use of digital names and profiles that may differ to an Applicant's real world name, either legal name or names with a ‘known as’.

In some embodiments, the processes in FIGS. 1 to 4 are all electronic processes, transmission, storage and processing that can be in the form of internet cloud computing through an internet accessible medium, or machine to machine direct interface or a computer system that requires human interface combined with a system, for example email functions.

In FIG. 3, an example of a method to automatically access, collect or extract the information from the Applicant's social network accounts approved and credentialed in FIG. 2 is shown. When referring to FIG. 3, 300 is an automated system process to access or compile and collect the information and is a series of computer code instructions and events whereby the system computer accesses each of the social networks identified in FIG. 2. In some embodiments, the system of the present invention contains a filter in its electronic communication with the social networks in 302 where the electronic request by the system to the social network will specifically exclude, or attempt to exclude based on data fields being requested or key word checking code algorithms (for example, key words dealing with health status or sexual orientation) for information associated with the Applicants social information that could be potential harmful for the Reviewer to view, this being a Protected Class Filter. For example, the Protected Class Filter will attempt to exclude information that could potentially be viewed as legally discriminatory to an Applicant (for example, information such as gender, age, health or sexual orientation status indicators recorded in the social network accounts). For two illustrative examples, the Protected Class Filter will not request the date of birth maintained on an Applicant social network profile as this could potentially be a discriminatory legal risk on age; and will not, for example, request organization's the Applicant has associated (for example “Likes” on Facebook) themselves with in a social setting as this could potentially be a legal health status discrimination risk to the Reviewer if they have socially linked themselves with an association that deals with a particular illness or disease.

In some embodiments, the compilation component 301 in FIG. 3 will then use automated software code and processes to retrieve information from the social networks identified and approved in FIG. 2. This will be done electronically by a system machine to the social network machine through the following methods: in 303 accessing those social network accounts supporting direct database access by means of an API in combination with the Credentials stored in the system for access to the identified social network account in FIG. 2. process 203 (this information being a combination of referencing and extracting data from the social network account for storage in the database of the Application Program outside of the social network); or in 304 accessing information by using internet protocols to simply retrieve data from a social network and use in a Display Method (ie not store the information in the Application Program database outside of the social network), a common internet protocol being iFrames (Inline Frames) or its successor in functionality to show information provided direct from another internet address interface without storing the information in a database; or a combination of the two retrieval methods.

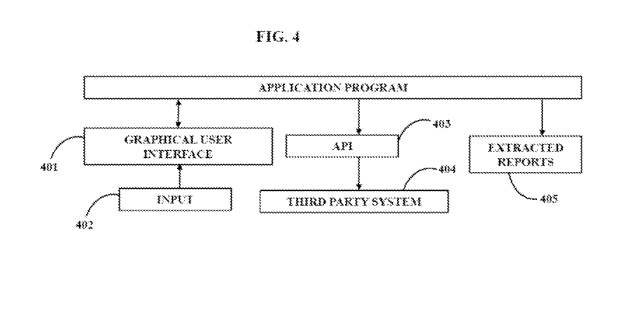

Information extracted using 303 will be stored in the Application Program database for later retrieval. Using 304, limited or no information of the activities in the social network account will be stored by the Application Program database but will be retrieved and displayed in real time using internet protocols from the original source social network per FIG. 4.

The compilation component will then identify social network accounts and retrieve or prepare to display information in FIG. 4, in one of the above two methods for multiple social network accounts per 305 that are Approved in 203 of FIG. 2.

The information from the social networks collected by 301 are designed to have two primary value returns for the Reviewer in an automated efficient manner: the first being reduced exposure to potential discriminatory lawsuit risk through the reduced information set returned in filtering provided by the Protected Class Filter; and then information relevant to a better assessment of the Applicant in terms of their semi-private and private conduct on their digital social networks including but not limited to how they communicate with other people in their network (for example language patterns and what the Applicant posts to others in their social network) and how they conduct themselves in the real world as evidenced by pictures posted in their private social networks using an automated platform.

In some embodiments perhaps best shown in FIG. 4, the system of the present invention provides a means in which information is returned to the Reviewer. The information extracted (previously extracted and stored per 303 or retrieved for display in real-time using internet protocols per 304) is available to (i) the Reviewer or other parties the Reviewer grants permission access to, or to (ii) the Applicant or other parties the Applicant grants permission access to. The information extracted (for example the Applicant's size and composition of their social network, the posts to others in their social network, pictures of their real world behavior posted on the network) is presented in 401 in an interactive electronic report form through a digital graphical user interface.

The system provides a Reviewer or Applicant, or persons to whom the Reviewer or Applicant has granted access permissions to the Applicant's specific graphical user interface, the ability in 402 to digitally input comments and ratings associated with the Applicant on the same graphical user interface. The illustrative example is for (i) a Reviewer to record their assessment of what they have reviewed as to the continued suitability of the Applicant, or (ii) an Applicant to record notational explanations of the content contained in the information returned in the graphical user interface. The extracted information can be provided to the Reviewer or Applicant directly as electronic information from the Application Program's database to a third party's computer system in 404 through the use of an API in 403, for example where the Reviewer or Applicant wishes to view the results extracted information in another system, for example where the Reviewer uses a broadly defined Strategic Human Resources Management system or component thereof.

The system in 401 supports reports (including PDF, Portable Document Format) the Reviewer can use to originate and send to other third parties using electronic shared means, for example PDF reports created and emailed from the system to other third parties (for example from a recruiter service provider to a prospective employer). The system in 405 supports reports (including PDF, Portable Document Format) that the Application Program compiles that the Applicant can receive and that they can send, either using an electronic interface provided to the Application Program or independently outside the Application Program (for example email or instant messenger systems) to one or multiple Reviewers who may or may not be registered with the Application Program. In one embodiment of this function of 405, it may be activated when the report is Applicant initiated as indicated in FIG. 2 process 203.

Although the subject matter has been described in language specific to specific features and or examples, it is understood that the subject matter defined in the appended claims is not necessarily limited to the specific features, acts or illustrative examples. Rather, the specific features and acts described are disclosed as example forms of implementing the claims.

Also, although the disclosure has been shown and described with respect to one or more implementations, equivalent alterations and modifications will occur to others skilled in the art based upon a reading and understanding of this specification and the annexed drawings. In particular regard to the various functions performed by the above described components (e.g., Application Program, Compilation Component, Information Filter, Graphical User Interface, API etc.), the terms used to describe such components are intended to correspond, unless otherwise indicated, to any component which performs the specified function of the described component (e.g., that is functionally equivalent), even though not structurally equivalent to the disclosed structure which performs the function in the illustrated examples or claims. In addition, while a particular feature of the disclosure may have been disclosed with respect to only one of several implementations, such feature may be combined with one or more other features of the other implementations or examples as may be desired and advantageous for any given or particular application.

### REFERENCES

US Patent Documents, hereby incorporated by reference with the present written specification.

Patent publication number: 2005/0055231
Filing Date: Feb. 4, 2004
Title: Candidate-initiated background check and verification
Inventor: Geoffrey C. Lee
Current U.S. Classification: 705/319; 705/321.

U.S. Pat. No. 8,126,904
Filing Date: Sep. 19, 2011
Issue date: Feb. 28, 2012
Title: System and method for managing digital footprints
Inventor: Jon S. Bettinger et al
Current U.S. Classification: 707/758 ; 707/609; 707/705

Patent publication number: 2004/0186852
Filing Date: Nov. 3, 2003
Title: Internet based system of employment referencing and employment history verification of a human capital database
Inventor: Les Rosen
Current U.S. Classification: 1/1; 707/999.107

U.S. Pat. No. 7,979,908
Filing Date: Feb. 10, 2006
Issue date: Jul. 12, 2011
Title: Method and system of verifying and authenticating background and consumer records
Inventor: Steven C. Millwee
Current U.S. Classification: 726/26; 713/166; 726/30

Patent publication number: 2008/0052098
Filing Date: Jan. 30, 2007
Title: Automation and streamlining of recruiting and background screening via bi-directional communication and process integration
Inventor: Stefano Malnati et al
Current U.S. Classification: 705/321

U.S. Pat. No. 7,707,204
Filing Date: Jun. 30, 2005
Issue date: Apr. 27, 2010
Title: Job seeking system and method for managing job listings
Inventor: Adam Hyder et al
Current U.S. Classification: 707/710; 707/722; 707/736; 707/755; 707/756; 707/811; 707/947

Patent publication number: 2010/0070875
Filing Date: Sep. 10, 2008
Title: Interactive Profile Presentation
Inventor: Andrzej Turski et al
Current U.S. Classification: 715/748; 707/E17.032

Patent publication number: 20080183488
Filing Date: Mar. 31, 2008
Title: Apparatus and methods for providing career employment services
Inventor: Vianello; Marc
Current U.S. Classification: 705/7.14.

Although the invention has been described with reference to the above examples, it will be understood that modifications and variations are encompassed within the spirit and scope of the invention. Accordingly, the invention is limited only by the following claims.

What is claimed is:

1. A computer implemented method for a third party Reviewer to electronically request a report of private and semi-private social network information from multiple social network accounts from an Applicant; and the Applicants approval of such request; or the Applicant independently of a Reviewer initiating such a request; and using an automated system to extract the private and semi-private information from one or many of the Applicants private social network accounts using an automated system; and presenting the extracted information to the Reviewer or Applicant through a graphical user interface or direct to a third party system or in an electronic report capable of being viewed through or extracted from the system, for the purpose of assessment of the Applicant by the Reviewer.

2. The method of claim 1 wherein the initiation of the electronic request to an Applicant by a Reviewer uses a manual method by selecting an initiation action electronic button in an internet enabled web browser.

3. The method of claim 1 wherein the request, whether automated or otherwise, by electronic message (email, instant messenger, webpage, text message or similar) is sent to the Applicant to identify their social network accounts; and then to approve or deny the service to have access to the private social network accounts through providing personal access credentials to the system of the Applicant's various social network accounts.

4. The method of claim 1 wherein the initiation of the electronic request by an Applicant independent of the Reviewer uses a manual method by selecting an initiation action electronic button in an internet enabled web browser.

5. The method of claim 1 wherein the system uses a compilation component to access, view or extract and compile private or semi-private information from the Applicant's social network accounts through internet protocols or API (Application Programming Interface) with Applicant stored credentials into the social networks.

6. The method of claim 1 further comprising an electronic communication application to prepare said report which includes at least one of the following: a graphical user interface of the Applicants private or semi-private information retrieved from the Applicant's social networks; and the process to view or produce and share reports (including PDF, Portable Document Format) the Reviewer or Applicant can use to send to other third parties; with the optional function for a Reviewer or Applicant to add input commentary and ratings of the reviewed retrieved information and an API (Application Programming Interface) or means for the system to provide the Applicants retrieved social network information to a third party computer system.

7. A computer implemented method for a third party Reviewer to request a report of private and semi-private social network information from an Applicant's social network accounts with an automated process whereby such viewed or extracted report information automatically removes, or attempts to remove, discriminatory or harmful information that the Reviewer is not able to view.

8. The method of claim 7 wherein certain determined information residing in an Applicant's social networks may contain or is identified to contain potentially protected class information that could be deemed discriminatory, including but not limited to such as gender, age or date of birth, health or sexual orientation status indicators.

9. The method of claim 7 wherein the computer implemented method creates a Protected Class Filter which removes, or attempts to remove, potentially discriminatory information residing in the Applicants social network from being reported to a Reviewer during compilation and when the Reviewer views the information.

10. The method of claim 7 wherein the computer implemented method uses a system compilation component to view or extract information from an Applicant's private and semi-private social network information, such access or compilation does not gather and specifically excludes accessing determined potentially discriminatory information sets residing in the Applicants social networks such that this is not retrieved or provided to the Reviewer.

11. The method of claim 7 wherein the computer implemented method uses a system viewing or reporting component to view or extract information from an Applicant's private and semi-private social network information by a Reviewer, information after accessing or retrieving but before being presented to a Reviewer, is automatically checked for information sets containing potentially discriminatory information and these removed or edited screened out so as not be viewed by the Reviewed.
